(19) United States
(12) Patent Application Publication
(10) Pub. No.: US 2023/0034147 A1
(43) Pub. Date: Feb. 2, 2023

(54) ADHESIVE TAPE

(71) Applicant: NITTO DENKO CORPORATION, Osaka (JP)

(72) Inventors: Yusuke YAMANARI, Ibaraki-shi (JP); Makoto SAITO, Ibaraki-shi (JP); Naoaki HIGUCHI, Ibaraki-shi (JP); Hiroki IEDA, Ibaraki-shi (JP)

(73) Assignee: NITTO DENKO CORPORATION, Osaka (JP)

(21) Appl. No.: 17/769,471

(22) PCT Filed: Sep. 28, 2020
(86) PCT No.: PCT/JP2020/036669

§ 371 Date: Apr. 15, 2022

(30) Foreign Application Priority Data
Nov. 27, 2019 (JP) 2019-214331

(51) Int. Cl. C09J 7/38; C09J 7/29; C09J 7/25

(52) U.S. Cl. CPC C09J 7/385; C09J 7/29; C09J 7/25; C09J 2301/312; C09J 2301/302; C09J 2301/162; C09J 2301/124

(57) ABSTRACT

Provided is a pressure-sensitive adhesive tape excellent in unevenness followability. The pressure-sensitive adhesive tape of the present invention includes: a base material layer; and a pressure-sensitive adhesive layer arranged on at least one side of the base material layer, wherein the pressure-sensitive adhesive tape has a dimensional change ratio at 23° C. and 50% RH of from −0.39 to −0.20, provided that the dimensional change ratio at 23° C. and 50% RH is calculated in accordance with a predetermined equation by: cutting the pressure-sensitive adhesive tape into a belt shape having a width of 20 mm to produce a measurement sample; and tensioning the measurement sample under an environment at 23° C. and 50% RH with a tensile tester at an initial chuck-to-chuck distance set to 20 mm and a tensile rate of 300 mm/min in a longitudinal direction of the measurement sample so that a deformation amount thereof becomes 100%.

### TECHNICAL FIELD

The present invention relates to a pressure-sensitive adhesive tape.

### BACKGROUND ART

A pressure-sensitive adhesive tape has been used in the fixation of structures of various shapes (e.g., Patent Literatures 1 to 3). However, when the pressure-sensitive adhesive tape is bonded to a corner portion (e.g., a corner portion of a wall) or a bending portion (e.g., a movable bending portion of a foldable member), a stress occurs in the pressure-sensitive adhesive tape, and hence the unevenness following of the pressure-sensitive adhesive tape cannot be sufficiently achieved yet.

When the pressure-sensitive adhesive tape is bonded to the corner portion or the bending portion, specifically, such a problem as described below occurs.

When the pressure-sensitive adhesive tape is bent with an angle, a compressing force acts on the radially inner side of the bent tape, and hence the deformation of the pressure-sensitive adhesive tape itself occurs so as to relax the force. Specifically, for example, a wrinkle is liable to occur in the tape.

When the pressure-sensitive adhesive tape is bent with an angle, a stress by which the tape is tensioned acts on the radially outer side of the bent tape. Accordingly, the floating of the tape from an adherend occurs at the time of the relaxation of the stress.

Also under a state in which the thickness of a site of the pressure-sensitive adhesive tape to be bent or a site thereof to be tensioned largely changes, a wrinkle is liable to occur in the tape, or the floating of the tape occurs. For example, when the pressure-sensitive adhesive tape is tensioned, the thickness of the pressure-sensitive adhesive tape remarkably reduces, and hence its floating from an adherend is liable to occur.

As described above, in the related-art pressure-sensitive adhesive tape, unevenness following cannot be sufficiently achieved yet.

In particular, when the pressure-sensitive adhesive tape is bonded to a movable bending portion, bending is repeated, and hence a state in which a bending mark (so-called “curl”) is left in the pressure-sensitive adhesive tape on the movable bending portion is established.

### CITATION LIST

### Patent Literature

[PTL 1] JP 2015-165023 A
[PTL 2] JP 2016-029155 A
[PTL 3] JP 2016-113506 A

### SUMMARY OF INVENTION

### Technical Problem

An object of the present invention is to provide a pressure-sensitive adhesive tape excellent in unevenness followability.

### Solution to Problem

According to one embodiment of the present invention, there is provided a pressure-sensitive adhesive tape, including: a base material layer; and a pressure-sensitive adhesive layer arranged on at least one side of the base material layer, wherein the pressure-sensitive adhesive tape has a dimensional change ratio at 23° C. and 50% RH of from −0.39 to −0.20, provided that the dimensional change ratio at 23° C. and 50% RH is calculated in accordance with the following equation by: cutting the pressure-sensitive adhesive tape into a belt shape having a width of 20 mm to produce a measurement sample; and tensioning the measurement sample under an environment at 23° C. and 50% RH with a tensile tester (manufactured by Shimadzu Corporation, name: Autograph AG-IS) at an initial chuck-to-chuck distance set to 20 mm and a tensile rate of 300 mm/min in a longitudinal direction of the measurement sample so that a deformation amount thereof becomes 100% (i.e., a length thereof becomes twice as long as an original length thereof):

Dimensional change ratio={(D−D0)/D0}/{(L−L0)/L0}

where L represents a length thereof in the longitudinal direction (tensile direction) after the tension, and D represents a length thereof in a lateral direction thereof (direction perpendicular to the tensile direction) after the tension.

In one embodiment, the pressure-sensitive adhesive tape of the present invention has a Young's modulus at 23° C. and 50% RH of from 0.2 MPa to 25 MPa.

In one embodiment, the pressure-sensitive adhesive tape of the present invention has a maximum stress of from 0.1 MPa to 10 MPa at a time of tension thereof by 100% at 23° C. and 50% RH and a tensile rate of 300 mm/min.

In one embodiment, in the pressure-sensitive adhesive tape of the present invention, a ratio (B/A) between a stress A applied to the pressure-sensitive adhesive tape immediately after the pressure-sensitive adhesive tape is tensioned by 100% at 23° C. and 50% RH and a tensile rate of 300 mm/min, and a stress B after holding of the 100% tension state for 1 second is from 0.7 to 1.0.

In one embodiment, the pressure-sensitive adhesive layer has a pressure-sensitive adhesive strength to a SUS plate of 5 N/20 mm or more at 23° C. and 50% RH, a tensile rate of 300 mm/min, and a peel angle of 180°.

In one embodiment, the pressure-sensitive adhesive tape includes the pressure-sensitive adhesive layer on one side of the base material layer, and further includes a matt coating layer on another side of the base material layer.

In one embodiment, the matt coating layer has a surface roughness Sa of from 0.3 μm to 0.9 μm.

In one embodiment, the pressure-sensitive adhesive tape of the present invention has a total thickness “d” of from 1 μm to 500 μm. The total thickness “d” refers to the thickness of the entirety of the pressure-sensitive adhesive tape excluding a release liner.

In one embodiment, a ratio (d1/d) of a total thickness d1 of the pressure-sensitive adhesive layer to the total thickness “d” is 0.7 or less.

In one embodiment, the base material layer contains at least one polar functional group-containing polymer selected from a condensation-type polymer and a polyaddition-type polymer.

In one embodiment, the polar functional group-containing polymer is at least one kind selected from polyamide, polyurethane, and polyurea.

In one embodiment, the polar functional group-containing polymer has at least one kind selected from an ether bond and an ester bond.

In one embodiment, the pressure-sensitive adhesive layer contains at least one kind selected from an acrylic pressure-sensitive adhesive, a rubber-based pressure-sensitive adhesive, a silicone-based pressure-sensitive adhesive, and a urethane-based pressure-sensitive adhesive.

In one embodiment, the pressure-sensitive adhesive tape of the present invention is a rolled body.

### Advantageous Effects of Invention

According to the present invention, the pressure-sensitive adhesive tape excellent in unevenness followability can be provided.

### BRIEF DESCRIPTION OF DRAWINGS

FIG. 1 is a schematic sectional view for illustrating one embodiment in the case where a pressure-sensitive adhesive tape of the present invention is a single-sided pressure-sensitive adhesive tape.

FIG. 2 is a schematic sectional view for illustrating one embodiment in the case where the pressure-sensitive adhesive tape of the present invention is a double-sided pressure-sensitive adhesive tape.

FIG. 3 is a schematic sectional view for illustrating one embodiment in the case where the pressure-sensitive adhesive tape of the present invention is a single-sided pressure-sensitive adhesive tape including a matt coating layer.

FIG. 4 is an explanatory view for calculating a dimensional change ratio.

### DESCRIPTION OF EMBODIMENTS

### <<<<Pressure-Sensitive Adhesive Tape>>>>

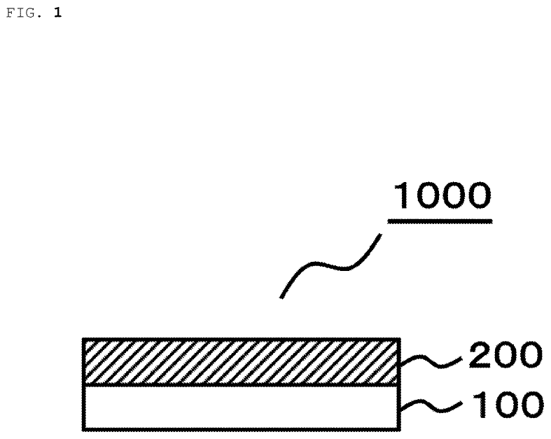

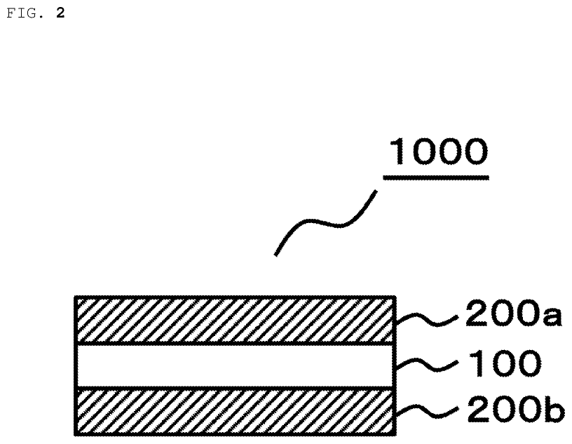

A pressure-sensitive adhesive tape of the present invention is a pressure-sensitive adhesive tape including: a base material layer; and a pressure-sensitive adhesive layer arranged on at least one side of the base material layer. That is, a pressure-sensitive adhesive tape 1000 of the present invention may be a pressure-sensitive adhesive tape (single-sided pressure-sensitive adhesive tape) including a pressure-sensitive adhesive layer 200 only on one side of a base material layer 100 as illustrated in FIG. 1, or may be a pressure-sensitive adhesive tape (double-sided pressure-sensitive adhesive tape) including pressure-sensitive adhesive layers 200a and 200b on both sides of the base material layer 100 as illustrated in FIG. 2.

The pressure-sensitive adhesive tape of the present invention may be provided as a rolled body. In this case, from the viewpoints of winding around the rolled body and unwinding from the rolled body, the pressure-sensitive adhesive tape of the present invention is typically a single-sided pressure-sensitive adhesive tape, and any appropriate release liner as described later is arranged on the surface of the pressure-sensitive adhesive layer opposite to the base material layer. In particular, both the surfaces of the release liner are each preferably subjected to release treatment.

The number of the base material layers may be one, or two or more. The number of the base material layers is preferably one because the effect of the present invention can be further expressed.

The number of the pressure-sensitive adhesive layers arranged on one side of the base material layer may be one, or two or more. The number of the pressure-sensitive adhesive layers is preferably one because the effect of the present invention can be further expressed.

The pressure-sensitive adhesive tape of the present invention may include any appropriate other layer except the base material layer and the pressure-sensitive adhesive layer to such an extent that the effect of the present invention is not impaired.

Any appropriate release liner may be arranged on the surface of the pressure-sensitive adhesive layer opposite to the base material layer for, for example, protecting the pressure-sensitive adhesive tape of the present invention until its use.

Examples of the release liner include: a release liner obtained by subjecting the surface of a base material (liner base material), such as paper or a plastic film, to silicone treatment; and a release liner obtained by laminating a polyolefin-based resin on the surface of a base material (liner base material), such as paper or a plastic film. Examples of the plastic film serving as the liner base material include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release liner is preferably from 1 μm to 500 μm, more preferably from 3 μm to 450 μm, still more preferably from 5 μm to 400 μm, particularly preferably from 10 μm to 300 μm.

At least one surface of the release liner is preferably subjected to release treatment. Any appropriate release treatment may be adopted as the release treatment to such an extent that the effect of the present invention is not impaired.

The total thickness “d” of the pressure-sensitive adhesive tape of the present invention is preferably from 1 μm to 500 μm, more preferably from 5 μm to 400 μm, still more preferably from 10 μm to 350 μm, particularly preferably from 15 μm to 300 μm, most preferably from 20 μm to 250 μm. When the total thickness “d” of the pressure-sensitive adhesive tape of the present invention falls within the ranges, the effect of the present invention can be further expressed.

The ratio (d1/d) of the total thickness d1 of the pressure-sensitive adhesive layer to the total thickness “d” of the pressure-sensitive adhesive tape of the present invention is preferably 0.7 or less, more preferably from 0.01 to 0.65, still more preferably from 0.05 to 0.6, particularly preferably from 0.1 to 0.57, most preferably from 0.15 to 0.55. When the ratio (d1/d) of the total thickness d1 of the pressure-sensitive adhesive layer to the total thickness “d” of the pressure-sensitive adhesive tape of the present invention falls within the ranges, the effect of the present invention can be further expressed. The units of the “d” and the d1 are identical to each other.

The dimensional change ratio of the pressure-sensitive adhesive tape of the present invention at 23° C. and 50% RH is from −0.39 to −0.20, preferably from −0.37 to −0.22, more preferably from −0.35 to −0.24, still more preferably from −0.33 to −0.25, particularly preferably from −0.32 to −0.26, most preferably from −0.31 to −0.27. When the dimensional change ratio of the pressure-sensitive adhesive tape of the present invention at 23° C. and 50% RH falls within the ranges, the pressure-sensitive adhesive tape of the present invention can be excellent in unevenness followability. When the dimensional change ratio of the pressure-sensitive adhesive tape at 23° C. largely exceeds the ranges, in the case where the tape is bonded to a convex portion of an adherend, its convex portion followability may deteriorate, and hence its floating from the adherend may occur. When the dimensional change ratio of the pressure-sensitive adhesive tape at 23° C. largely falls short of the ranges, the tape may be liable to flow, and hence a wrinkle may be liable to occur in the tape. A method of measuring the dimensional change ratio is described in detail later.

The Young's modulus of the pressure-sensitive adhesive tape of the present invention at 23° C. and 50% RH is preferably from 0.2 MPa to 25 MPa, more preferably from 1.0 MPa to 20 MPa, still more preferably from 1.0 MPa to 15 MPa, particularly preferably from 1.0 MPa to 10 MPa. When the Young's modulus of the pressure-sensitive adhesive tape of the present invention at 23° C. and 50% RH falls within the ranges, the effect of the present invention can be further expressed. In the case where the Young's modulus of the pressure-sensitive adhesive tape at 23° C. and 50% RH is less than 0.2 MPa, when the pressure-sensitive adhesive tape is bent with an angle, there is a risk in that tension on its radially outer side cannot be sufficiently held with respect to compression on its radially inner side. Accordingly, there is a risk in that the thickness of the tape is liable to change, and hence the floating thereof from an adherend is liable to occur. In the case where the Young's modulus of the pressure-sensitive adhesive tape at 23° C. is more than 25 MPa, it may be impossible to easily deform the pressure-sensitive adhesive tape. A method of measuring the Young's modulus is described in detail later.

The pressure-sensitive adhesive tape of the present invention has a maximum stress of preferably from 0.1 MPa to 10 MPa, more preferably from 0.2 MPa to 9 MPa, still more preferably from 0.3 MPa to 8 MPa, still further more preferably from 0.5 MPa to 7 MPa, particularly preferably from 0.8 MPa to 6 MPa, most preferably from 1.0 MPa to 4 MPa at the time of its tension by 100% at 23° C. and 50% RH and a tensile rate of 300 mm/min. When the maximum stress of the pressure-sensitive adhesive tape of the present invention at the time of the 100% tension at 23° C. and 50% RH and a tensile rate of 300 mm/min falls within the ranges, the effect of the present invention can be further expressed. When the maximum stress of the pressure-sensitive adhesive tape at the time of the 100% tension at 23° C. and 50% RH and a tensile rate of 300 mm/min is less than 0.1 MPa, the tape may be liable to easily deform, and hence a problem in terms of its handleability such as processability may occur. When the maximum stress of the pressure-sensitive adhesive tape at the time of the 100% tension at 23° C. and 50% RH and a tensile rate of 300 mm/min is more than 6.0 MPa, a large force may be required at the time of the bending of the pressure-sensitive adhesive tape with an angle. Accordingly, there is a risk in that a compressive stress on the radially inner side of the tape increases, and hence a wrinkle is liable to occur in the tape. A method of measuring the maximum stress is described in detail later.

A ratio (B/A) between a stress A applied to the pressure-sensitive adhesive tape of the present invention immediately after the pressure-sensitive adhesive tape is tensioned by 100% at 23° C. and 50% RH and a tensile rate of 300 mm/min, and a stress B after the holding of the 100% tension state for 1 second is preferably from 0.7 to 1.0, more preferably from 0.73 to 1.0, still more preferably from 0.75 to 1.0, particularly preferably from 0.77 to 1.0, most preferably from 0.80 to 1.0. When the ratio (B/A) between the stress A applied to the pressure-sensitive adhesive tape of the present invention immediately after the pressure-sensitive adhesive tape is tensioned by 100% at 23° C. and 50% RH and a tensile rate of 300 mm/min, and the stress B after the holding of the 100% tension state for 1 second falls within the ranges, the effect of the present invention can be further expressed. When the ratio (B/A) between the stress A applied to the pressure-sensitive adhesive tape immediately after the pressure-sensitive adhesive tape is tensioned by 100% at 23° C. and 50% RH and a tensile rate of 300 mm/min, and the stress B after the holding of the 100% tension state for 1 second is less than 0.7, the pressure-sensitive adhesive tape is completely elongated in a short time period, and hence the following risk occurs: even when the pressure-sensitive adhesive tape can follow unevenness, in the case where a wrinkle occurs therein, its rebonding or the like cannot be performed; or the thickness of the pressure-sensitive adhesive tape changes. A method of measuring the ratio (B/A) is described in detail later.

The pressure-sensitive adhesive layer of the pressure-sensitive adhesive tape of the present invention has a pressure-sensitive adhesive strength to a SUS plate of preferably 5 N/20 mm or more, more preferably from 5 N/20 mm to 100 N/20 mm, still more preferably from 5 N/20 mm to 50 N/20 mm, particularly preferably from 5 N/20 mm to 30 N/20 mm, most preferably from 5 N/20 mm to 20 N/20 mm at 23° C. and 50% RH, a tensile rate of 300 mm/min, and a peel angle of 180°. When the pressure-sensitive adhesive strength of the pressure-sensitive adhesive layer of the pressure-sensitive adhesive tape of the present invention to the SUS plate at 23° C. and 50% RH, a tensile rate of 300 mm/min, and a peel angle of 180° falls within the ranges, the effect of the present invention can be further expressed.

### <<Base Material Layer>>

The thickness of the base material layer is preferably from 1 μm to 500 μm, more preferably from 5 μm to 400 μm, still more preferably from 10 μm to 300 μm, particularly preferably from 15 μm to 200 μm, most preferably from 20 μm to 150 μm. When the thickness of the base material layer falls within the ranges, the effect of the present invention can be further expressed.

Any appropriate material may be adopted as a material for the base material layer to such an extent that the effect of the present invention is not impaired. Such material preferably contains at least one polar functional group-containing polymer selected from a condensation-type polymer and a polyaddition-type polymer. That is, the base material layer preferably contains the at least one polar functional group-containing polymer selected from the condensation-type polymer and the polyaddition-type polymer.

The content of the at least one polar functional group-containing polymer selected from the condensation-type polymer and the polyaddition-type polymer in the base material layer is preferably from 50 wt % to 100 wt % because the effect of the present invention can be further expressed, and the content is more preferably from 70 wt % to 100 wt %, still more preferably from 90 wt % to 100 wt %, particularly preferably from 95 wt % to 100 wt %, most preferably from 98 wt % to 100 wt %.

The at least one polar functional group-containing polymer selected from the condensation-type polymer and the polyaddition-type polymer has a polar functional group such as a carbonyl group in its polymer main chain. Accordingly, an intermolecular force stronger than that of a radical polymerization-type polymer acts on the polymer, and hence the polymer may have a network structure that does not depend on a covalent bond. A polymer having a large amount of a network structure that depends on a covalent bond has excessively high elasticity, and hence the unevenness followability of the pressure-sensitive adhesive tape may reduce. In each of the condensation-type polymer and the polyaddition-type polymer each having a network structure that does not depend on a covalent bond, an intermolecular force caused by a polar functional group is weaker than an intermolecular force caused by a covalent bond, and hence the deformation or the like of the tape is easily caused even by smaller energy (energy such as work done by, for example, a stress applied to the tape) to relax the stress. After the relaxation, an intermolecular force acts between the polar functional groups of the polymer again (for example, the combination of the polar functional groups between which an intermolecular force occurs changes), and hence the unevenness followability may be improved; for example, the tape can hold its bent shape.

The polar functional group-containing polymer is preferably at least one kind selected from polyamide, polyurethane, and polyurea. The intermolecular force of a polymer containing a hydrogen-bondable polar functional group (more precisely, a hydrogen-bondable polar functional group having a hydrogen donor property), such as the polyamide, the polyurethane, or the polyurea, is said to be capable of being cleaved (the combination of the hydrogen-bondable functional groups of the polymer between which an intermolecular force occurs is said to be changed) by energy about 1/10 as large as that of a covalent bond, and hence the cleavage of the intermolecular force may be effectively caused by thermal energy applied to the polymer at about room temperature or energy generated by work done by a stress or the like caused by the bending or the like of the pressure-sensitive adhesive tape. Accordingly, the unevenness followability can be further improved.

The base material layer more preferably contains a polar functional group-containing polymer that is the polyaddition-type polymer. In the polyaddition-type polymer, a monomer having various functional groups may be adopted, and an operation of transforming the monomer into the polymer is easy. Various properties can be imparted to the polyaddition-type polymer by exploiting those features.

The polar functional group-containing polymer that is the polyaddition-type polymer may have at least one kind selected from an ether bond and an ester bond. The ether bond may be introduced by adopting a monomer having an ether bond at the time of the production of the polyaddition-type polymer. The ester bond may be introduced by adopting a monomer having an ester bond at the time of the production of the polyaddition-type polymer. For example, when polyurethane is adopted as the polar functional group-containing polymer, polyurethane having an ether bond is, for example, ether-based polyurethane. Polyurethane having an ester bond is, for example, ester-based polyurethane.

When a monomer having an ether bond is adopted at the time of the production of the polyaddition-type polymer, the elasticity of the polyaddition-type polymer can be weakened, and molecular flexibility can be imparted thereto. When a monomer having an ester bond is adopted at the time of the production of the polyaddition-type polymer, rigidity can be imparted to the polyaddition-type polymer. Therefore, for example, when the monomer having an ether bond and the monomer having an ester bond are appropriately combined with each other, or are each adopted alone, at the time of the production of the polyaddition-type polymer, the elasticity and rigidity of the polyaddition-type polymer can be adjusted, and hence the effect of the present invention can be further expressed.

When polyurethane is adopted as the polar functional group-containing polymer, a hydroxy group-containing monomer may be adopted at the time of the production of the polyurethane. When the hydroxy group-containing monomer is adopted at the time of the production of the polyurethane, an isocyanate monomer to be used in a polyaddition reaction at the time of the production of the polyurethane and the hydroxy group-containing monomer may react with each other to introduce a covalent-bondable network structure into the polyurethane. In addition, the hydroxy group-containing monomer can be collectively loaded as a raw material for the polyurethane, and hence labor such as the loading of the raw material for the polyurethane after the preparation of the polyurethane can be simplified.

The polar functional group-containing monomer is preferably polyurethane because the effect of the present invention can be further expressed. The polyurethane is a polymer compound synthesized by subjecting a polyol (e.g., a diol) and a polyisocyanate (e.g., a diisocyanate) at predetermined ratios to a polyaddition reaction.

Examples of the polyol that may be used in the synthesis of the polyurethane include: diols, such as ethylene glycol, propylene glycol, 1,3-propanediol, 1,4-butanediol, 1,5-pentanediol, neopentyl glycol, 1,6-hexanediol, 1,8-octanediol, polyoxytetramethylene glycol, diethylene glycol, polyethylene glycol, and polypropylene glycol; polyester polyols each serving as a polycondensate of the diol and a dicarboxylic acid (e.g., adipic acid, azelaic acid, or sebacic acid); and carbonate diols such as a polyalkylene carbonate diol. The number of kinds of those polyols may be only one, or two or more.

Examples of the polyisocyanate that may be used in the synthesis of the polyurethane include aromatic, aliphatic, and alicyclic diisocyanates, and multimers (e.g., dimers or trimers) of those diisocyanates. Examples of the diisocyanate include tolylene diisocyanate, diphenylmethane diisocyanate, hexamethylene diisocyanate, xylylene diisocyanate, hydrogenated xylylene diisocyanate, isophorone diisocyanate, hydrogenated diphenylmethane diisocyanate, 1,5-naphthylene diisocyanate, 1,3-phenylene diisocyanate, 1,4-phenylene diisocyanate, butane-1,4-diisocyanate, 2,2,4-trimethylhexamethylene diisocyanate, 2,4,4-trimethylhexamethylene diisocyanate, cyclohexane-1,4-diisocyanate, dicyclohexylmethane-4,4-diisocyanate, 1,3-bis(isocyanatomethyl)cyclohexane, methylcyclohexane diisocyanate, and m-tetramethylxylylene diisocyanate. The number of kinds of those polyisocyanates may be only one, or two or more.

In addition to the polyol and the polyisocyanate, any other copolymerizable component may be introduced into the polyurethane. Examples of the other copolymerizable component include a monocarboxylic acid, a dicarboxylic acid, a polycarboxylic acid that is trifunctional or more, a hydroxycarboxylic acid, an alkoxycarboxylic acid, and derivatives thereof. The number of kinds of the other copolymerizable components may be only one, or two or more. The content of the other copolymerizable component in the polyurethane is preferably less than 30 wt %, more preferably less than 10 wt %, still more preferably less than 5 wt %.

The 100% modulus of the base material layer falls within the ranges of preferably from 0.5 MPa to 10 MPa, more preferably from 1 MPa to 9 MPa, still more preferably from 1.5 MPa to 8 MPa, particularly preferably from 2 MPa to 7 MPa from the viewpoint of the ease with which the layer deforms.

### <<Pressure-Sensitive Adhesive Layer>>

The thickness of the pressure-sensitive adhesive layer is preferably from 1 μm to 500 μm, more preferably from 3 μm to 300 μm, still more preferably from 5 μm to 200 μm, particularly preferably from 7 μm to 100 μm, most preferably from 10 μm to 70 μm. When the thickness of the pressure-sensitive adhesive layer falls within the ranges, the effect of the present invention can be further expressed.

The pressure-sensitive adhesive layer contains a base polymer. The number of kinds of the base polymers may be only one, or two or more. The content of the base polymer in the pressure-sensitive adhesive layer is preferably from 30 wt % to 95 wt % because the effect of the present invention can be further expressed, and the content is more preferably from 40 wt % to 90 wt %, still more preferably from 50 wt % to 80 wt %.

The base polymer is preferably, for example, at least one kind selected from an acrylic polymer, a rubber-based polymer, a silicone-based polymer, and a urethane-based polymer because the effect of the present invention can be further expressed. That is, the pressure-sensitive adhesive layer preferably contains at least one kind selected from an acrylic pressure-sensitive adhesive containing the acrylic polymer, a rubber-based pressure-sensitive adhesive containing the rubber-based polymer, a silicone-based pressure-sensitive adhesive containing the silicone-based polymer, and a urethane-based pressure-sensitive adhesive containing the urethane-based polymer. In the following description, the acrylic pressure-sensitive adhesive is described in detail as a typical example.

### <Acrylic Pressure-Sensitive Adhesive>

The acrylic pressure-sensitive adhesive contains the acrylic polymer as its base polymer. The acrylic pressure-sensitive adhesive may contain a tackifier resin. The acrylic pressure-sensitive adhesive may contain a cross-linking agent.

When the acrylic pressure-sensitive adhesive contains the acrylic polymer, the tackifier resin, and the cross-linking agent, the content of the sum total amount of the acrylic polymer, the tackifier resin, and the cross-linking agent with respect to the total amount of the acrylic pressure-sensitive adhesive is preferably 95 wt % or more because the effect of the present invention can be further expressed, and the content is more preferably 97 wt % or more, still more preferably 99 wt % or more.

### (Acrylic Polymer)

The acrylic polymer is preferably, for example, a polymerized product of monomer components that contain an alkyl (meth)acrylate as a main monomer and that may further contain a sub-monomer having copolymerizability with the main monomer. The term “main monomer” as used herein refers to a component accounting for more than 50 wt % of the entirety of the monomer components.

For example, a compound represented by the following formula (1) may be suitably used as the alkyl (meth)acrylate.

CH₂═C(R¹)COOR² (1)

Herein, in the formula (1), R¹ represents a hydrogen atom or a methyl group, and R² represents a chain-like alkyl group having 1 to 20 carbon atoms (hereinafter, such range of the number of carbon atoms is sometimes represented as “C1-20”). R² represents preferably a C1-14 chain-like alkyl group, more preferably a C2-10 chain-like alkyl group, still more preferably a C4-8 chain-like alkyl group from the viewpoint of, for example, the storage modulus of elasticity of the pressure-sensitive adhesive layer. The term “chain-like” as used herein is meant to comprehend a linear group and a branched group.

Examples of the alkyl (meth)acrylate in which R² represents a C1-20 chain-like alkyl group include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth) acrylate, heptadecyl (meth) acrylate, octadecyl (meth) acrylate, isostearyl (meth) acrylate, nonadecyl (meth)acrylate, and eicosyl (meth)acrylate. The number of kinds of those alkyl (meth)acrylates may be only one, or two or more.

The alkyl (meth)acrylate is preferably, for example, n-butyl acrylate (BA) or 2-ethylhexyl acrylate (2EHA) because the effect of the present invention can be further expressed.

The content of the alkyl (meth)acrylate in all the monomer components to be used in the synthesis of the acrylic polymer is preferably 70 wt % or more because the effect of the present invention can be further expressed, and the content is more preferably 85 wt % or more, still more preferably 90 wt % or more. The upper limit of the content of the alkyl (meth)acrylate is preferably 99.5 wt % or less, more preferably 99 wt % or less. However, the acrylic polymer may be obtained by polymerizing substantially only the alkyl (meth)acrylate.

When an alkyl (meth)acrylate in which R² represents a C4-8 chain-like alkyl group is used, the ratio of the alkyl (meth)acrylate in which R² represents a C4-8 chain-like alkyl group out of the alkyl (meth)acrylates in the monomer components is preferably 50 wt % or more because the effect of the present invention can be further expressed, and the ratio is more preferably 70 wt % or more, still more preferably 90 wt % or more, particularly preferably 95 wt % or more, most preferably from 99 wt % to 100 wt %.

An acrylic polymer in which n-butyl acrylate (BA) accounts for 50 wt % or more of all the monomer components is given as one embodiment of the acrylic polymer. In this case, the content of n-butyl acrylate (BA) in all the monomer components is preferably more than 50 wt % and 100 wt % or less because the effect of the present invention can be further expressed, and the content is more preferably from 55 wt % to 95 wt %, still more preferably from 60 wt % to 90 wt %, particularly preferably from 63 wt % to 85 wt %, most preferably from 65 wt % to 80 wt %. All the monomer components may further contain 2-ethylhexyl acrylate (2EHA) at a ratio smaller than that of n-butyl acrylate (BA).

An acrylic polymer in which 2-ethylhexyl acrylate (2EHA) accounts for less than 50 wt % of all the monomer components is given as one embodiment of the acrylic polymer. In this case, the content of 2-ethylhexyl acrylate (2EHA) in all the monomer components is preferably more than 0 wt % and 48 wt % or less because the effect of the present invention can be further expressed, and the content is more preferably from 5 wt % to 45 wt %, still more preferably from 10 wt % to 43 wt %, particularly preferably from 15 wt % to 40 wt %, most preferably from 20 wt % to 35 wt %. All the monomer components may further contain n-butyl acrylate (BA) at a ratio larger than that of 2-ethylhexyl acrylate (2EHA).

The acrylic polymer may be copolymerized with any other monomer to such an extent that the effect of the present invention is not impaired. The other monomer may be used for the purpose of, for example, adjusting the glass transition temperature (Tg) of the acrylic polymer or adjusting the pressure-sensitive adhesive performance thereof. As a monomer that may improve the cohesive strength and heat resistance of the pressure-sensitive adhesive, there are given, for example, a sulfonic acid group-containing monomer, a phosphoric acid group-containing monomer, a cyano group-containing monomer, a vinyl ester, and an aromatic vinyl compound. Of those, a vinyl ester is preferred. Specific examples of the vinyl ester include vinyl acetate (VAc), vinyl propionate, and vinyl laurate. Of those, vinyl acetate (VAc) is preferred.

The number of kinds of the “other monomers” may be only one, or two or more. The content of the other monomer in all the monomer components is preferably from 0.001 wt % to 40 wt %, more preferably from 0.01 wt % to 40 wt %, still more preferably from 0.1 wt % to 10 wt %, particularly preferably from 0.5 wt % to 5 wt %, most preferably from 1 wt % to 3 wt %.

Examples of the other monomer that may introduce a functional group capable of serving as a cross-linking base point into the acrylic polymer, or that may contribute to an improvement in adhesive strength include a hydroxy group (OH group)-containing monomer, a carboxy group-containing monomer, an acid anhydride group-containing monomer, an amide group-containing monomer, an amino group-containing monomer, an imide group-containing monomer, an epoxy group-containing monomer, (meth)acryloylmorpholine, and a vinyl ether.

An acrylic polymer copolymerized with the carboxy group-containing monomer as the other monomer is given as one embodiment of the acrylic polymer. Examples of the carboxy group-containing monomer include acrylic acid (AA), methacrylic acid (MAA), carboxyethyl (meth)acrylate, carboxypentyl (meth)acrylate, itaconic acid, maleic acid, fumaric acid, crotonic acid, and isocrotonic acid. Of those, for example, acrylic acid (AA) or methacrylic acid (MAA) is preferred as the carboxy group-containing monomer because the effect of the present invention can be further expressed, and acrylic acid (AA) is more preferred.

When the carboxy group-containing monomer is adopted as the other monomer, the content of the other monomer in all the monomer components is preferably from 0.1 wt % to 10 wt % because the effect of the present invention can be further expressed, and the content is more preferably from 0.2 wt % to 8 wt %, still more preferably from 0.5 wt % to 5 wt %, particularly preferably from 0.7 wt % to 4 wt %, most preferably from 1 wt % to 3 wt %.

An acrylic polymer copolymerized with the hydroxy group-containing monomer as the other monomer is given as one embodiment of the acrylic polymer. Examples of the hydroxy group-containing monomer include: hydroxyalkyl (meth)acrylates, such as 2-hydroxyethyl (meth)acrylate, 2-hydroxypropyl (meth) acrylate, 3-hydroxypropyl (meth)acrylate, 2-hydroxybutyl (meth) acrylate, and 4-hydroxybutyl (meth)acrylate; polypropylene glycol mono(meth)acrylate; and N-hydroxyethyl(meth)acrylamide. Of those, for example, a hydroxyalkyl (meth)acrylate including a linear alkyl group having 2 to 4 carbon atoms is preferred as the hydroxy group-containing monomer because the effect of the present invention can be further expressed, and specific examples thereof include 2-hydroxyethyl acrylate (HEA) and 4-hydroxybutyl acrylate (4HBA), and 4-hydroxybutyl acrylate (4HBA) is more preferred.

When the hydroxy group-containing monomer is adopted as the other monomer, the content of the other monomer in all the monomer components is preferably from 0.001 wt % to 10 wt % because the effect of the present invention can be further expressed, and the content is more preferably from 0.01 wt % to 5 wt %, still more preferably from 0.02 wt % to 2 wt %, particularly preferably from 0.03 wt % to 1 wt %, most preferably from 0.05 wt % to 0.5 wt %.

The Tg of the base polymer may be, for example, −80° C. or more because the effect of the present invention can be further expressed. The base polymer (suitably the acrylic polymer) is designed so that its Tg may be preferably −15° C. or less from the viewpoint of improving the deformability of the pressure-sensitive adhesive layer with respect to a shear direction. In some embodiments, the Tg of the base polymer is, for example, preferably −25° C. or less, more preferably −40° C. or less, still more preferably −50° C. or less. The base polymer is designed so that its Tg may be, for example, preferably −70° C. or more (more preferably −65° C. or more, still more preferably −60° C. or more) from the viewpoint of improving the cohesiveness and shape recoverability of the polymer.

The Tg of the base polymer refers to a value determined from Fox's equation on the basis of the Tg of a homopolymer of each monomer for forming the base polymer and the weight fraction (copolymerization ratio on a weight basis) of the monomer. As described below, Fox's equation is a relational equation between the Tg of a copolymer and the glass transition temperature Tgi of a homopolymer obtained by the homopolymerization of each of monomers for forming the copolymer.

1/Tg=Σ(Wi/Tgi)

In Fox's equation described above, Tg represents the glass transition temperature (unit: K) of the copolymer, Wi represents the weight fraction (copolymerization ratio on a weight basis) of a monomer “i” in the copolymer, and Tgi represents the glass transition temperature (unit: K) of the homopolymer of the monomer “i”. A value described in a known material is adopted as the Tg of a homopolymer.

Specifically, for example, the following values may each be used as the Tg of a homopolymer.

| | | |
|---|---|---|
| 2-Ethylhexyl acrylate | −70° | C. |
| n-Butyl acrylate | −55° | C. |
| Acrylic acid | 106° | C. |
| 2-Hydroxyethyl acrylate | −15° | C. |
| 4-Hydroxybutyl acrylate | −40° | C. |

A numerical value described in “Polymer Handbook” (3rd edition, John Wiley & Sons, Inc., 1989) may be used as the Tg of a homopolymer except those listed above. When a plurality of numerical values are described in the above-mentioned “Polymer Handbook”, a conventional value is adopted. With regard to a monomer that is not described in the above-mentioned “Polymer Handbook”, the catalog value of the manufacturer of the monomer is adopted. A value obtained by a measurement method described in JP 2007-51271 A is used as the Tg of a homopolymer of a monomer which is not described in the above-mentioned “Polymer Handbook” and for which the catalog value of the manufacturer of the monomer is not provided.

Various polymerization methods known as approaches to synthesizing acrylic polymers, such as a solution polymerization method, an emulsion polymerization method, a bulk polymerization method, and a suspension polymerization method, may each be appropriately adopted as a method of obtaining the acrylic polymer. Of those polymerization methods, a solution polymerization method may be preferably used. A collective loading system involving supplying the total amount of the monomer components in one stroke, a continuous supply (dropping) system, a divided supply (dropping) system, or the like may be appropriately adopted as a monomer supply method at the time of the performance of the solution polymerization. A polymerization temperature may be appropriately selected in accordance with, for example, the kinds of the monomers and a solvent to be used, and the kind of a polymerization initiator. The polymerization temperature is preferably 20° C. or more, more preferably 30° C. or more, still more preferably 40° C. or more, and is preferably 170° C. or less, more preferably 160° C. or less, still more preferably 140° C. or less. Such active energy ray irradiation polymerization as described below may be adopted as the method of obtaining the acrylic polymer: photopolymerization performed (typically performed in the presence of a photopolymerization initiator) by irradiating the monomer components with light such as UV; or radiation polymerization performed by irradiating the monomer components with a radiation, such as a β ray or a γ ray.

The solvent (polymerization solvent) to be used in the solution polymerization may be appropriately selected from any appropriate organic solvents. Examples thereof include: aromatic compounds (typically aromatic hydrocarbons), such as toluene; acetic acid esters, such as ethyl acetate; and aliphatic or alicyclic hydrocarbons, such as hexane and cyclohexane.

The initiator (polymerization initiator) to be used in the polymerization may be appropriately selected from any appropriate polymerization initiators in accordance with the kind of the polymerization method. The number of kinds of the polymerization initiators may be only one, or two or more. Examples of such polymerization initiator include: azo-based polymerization initiators, such as 2,2′-azobisisobutyronitrile (AIBN); persulfuric acid salts, such as potassium persulfate; peroxide-based initiators, such as benzoyl peroxide and hydrogen peroxide; substituted ethane-based initiators, such as phenyl-substituted ethane; and aromatic carbonyl compounds. Other examples of the polymerization initiator include redox-type initiators each obtained by combining a peroxide and a reducing agent.

The usage amount of the polymerization initiator is preferably from 0.005 part by weight to 1 part by weight, more preferably from 0.01 part by weight to 1 part by weight with respect to 100 parts by weight of all the monomer components.

The acrylic polymer has a Mw of preferably from 10×10⁴ to 500×10⁴, more preferably from 10×10⁴ to 150×10⁴, still more preferably from 20×10⁴ to 75×10⁴, particularly preferably from 35×10⁴ to 65×10⁴. Herein, the Mw refers to a value in terms of standard polystyrene obtained by gel permeation chromatography (GPC). For example, a product available under the model name “HLC-8320GPC” (column: TSKgel GMH-H(S), manufactured by Tosoh Corporation) may be used as a GPC apparatus.

### (Tackifier Resin)

The acrylic pressure-sensitive adhesive may contain a tackifier resin because the effect of the present invention can be further expressed. Examples of the tackifier resin include a rosin-based tackifier resin, a terpene-based tackifier resin, a hydrocarbon-based tackifier resin, an epoxy-based tackifier resin, a polyamide-based tackifier resin, an elastomer-based tackifier resin, a phenol-based tackifier resin, and a ketone-based tackifier resin. The number of kinds of the tackifier resins may be only one, or two or more.

The usage amount of the tackifier resin is preferably from 5 parts by weight to 70 parts by weight with respect to 100 parts by weight of the base polymer because the effect of the present invention can be further expressed, and the usage amount is more preferably from 10 parts by weight to 60 parts by weight, still more preferably from 15 parts by weight to 50 parts by weight, still further more preferably from 20 parts by weight to 45 parts by weight, particularly preferably from 25 parts by weight to 40 parts by weight, most preferably from 25 parts by weight to 35 parts by weight.

The tackifier resin preferably contains a tackifier resin TL having a softening point of less than 105° C. because the effect of the present invention can be further expressed. The tackifier resin TL can effectively contribute to an improvement in deformability of the pressure-sensitive adhesive layer in its plane direction (shear direction). The softening point of a tackifier resin to be used as the tackifier resin TL is preferably from 50° C. to 103° C., more preferably from 60° C. to 100° C., still more preferably from 65° C. to 95° C., particularly preferably from 70° C. to 90° C., most preferably from 75° C. to 85° C. from the viewpoint of obtaining a higher deformability-improving effect.

The softening point of the tackifier resin is defined as a value measured on the basis of a softening point test method (ring and ball method) specified in JIS K5902 and JIS K2207. Specifically, the sample is forthwith fused at as low a temperature as possible, and the fused sample is filled into a ring placed on a flat metal plate while attention is paid so that no bubbles may occur therein. After the sample has been cooled, a portion rising from a plane including the upper end of the ring is cut off with a knife that has been somewhat heated. Next, a support (ring stand) is loaded into a glass vessel (heating bath) having a diameter of 85 mm or more and a height of 127 mm or more, and glycerin is poured into the vessel until its depth becomes 90 mm or more. Next, a steel ball (having a diameter of 9.5 mm and a weight of 3.5 g) and the ring filled with the sample are immersed in glycerin so as not to be in contact with each other, and the temperature of glycerin is kept at 20° C.±5° C. for 15 minutes. Next, the steel ball is mounted on the center of the surface of the sample in the ring, and the resultant is placed at a fixed position on the support. Next, a distance from the upper end of the ring to the surface of glycerin is kept at 50 mm. A temperature gauge is placed in the vessel, and the position of the center of the mercury ball of the temperature gauge is set at the same height as that of the center of the ring, followed by the heating of the vessel. The flame of a Bunsen burner to be used in the heating is brought into contact with a midpoint between the center and edge of the bottom of the vessel so that the heating may be uniformly performed. The rate at which the temperature of the bath increases after having reached 40° C. since the start of the heating needs to be 5.0° C.±0.5° C. per minute. A temperature when the sample gradually softens to flow down from the ring, and is finally brought into contact with the bottom plate of the ring is read, and the read temperature is adopted as the softening point. The simultaneous measurement of the softening points of two or more samples is performed, and the average of the measured values is adopted.

The usage amount of the tackifier resin TL is preferably from 5 parts by weight to 50 parts by weight with respect to 100 parts by weight of the base polymer because the effect of the present invention can be further expressed, and the usage amount is more preferably from 10 parts by weight to 45 parts by weight, still more preferably from 15 parts by weight to 40 parts by weight, particularly preferably from 20 parts by weight to 35 parts by weight, most preferably from 25 parts by weight to 32 parts by weight.

One or two or more kinds appropriately selected from those each having a softening point of less than 105° C. out of the tackifier resins listed above may each be adopted as the tackifier resin TL. The tackifier resin TL preferably contains a rosin-based resin.

Examples of the rosin-based resin that may be preferably adopted as the tackifier resin TL include rosin esters, such as an unmodified rosin ester and a modified rosin ester. An example of the modified rosin ester is a hydrogenated rosin ester.

The tackifier resin TL preferably contains a hydrogenated rosin ester because the effect of the present invention can be further expressed. The softening point of the hydrogenated rosin ester is preferably less than 105° C. because the effect of the present invention can be further expressed, and the softening point is more preferably from 50° C. to 100° C., still more preferably from 60° C. to 90° C., particularly preferably from 70° C. to 85° C., most preferably from 75° C. to 85° C.

The tackifier resin TL may contain a non-hydrogenated rosin ester. The term “non-hydrogenated rosin ester” as used herein is a concept comprehensively referring to those except the hydrogenated rosin ester out of the above-mentioned rosin esters. Examples of the non-hydrogenated rosin ester include an unmodified rosin ester, a disproportionated rosin ester, and a polymerized rosin ester.

The softening point of the non-hydrogenated rosin ester is preferably less than 105° C. because the effect of the present invention can be further expressed, and the softening point is more preferably from 50° C. to 100° C., still more preferably from 60° C. to 90° C., particularly preferably from 70° C. to 85° C., most preferably from 75° C. to 85° C.

The tackifier resin TL may contain any other tackifier resin in addition to the rosin-based resin. One or two or more kinds appropriately selected from those each having a softening point of less than 105° C. out of the tackifier resins listed above may each be adopted as the other tackifier resin. The tackifier resin TL may contain, for example, the rosin-based resin and a terpene resin.

The content of the rosin-based resin in the entirety of the tackifier resin TL is preferably more than 50 wt % because the effect of the present invention can be further expressed, and the content is more preferably from 55 wt % to 100 wt %, still more preferably from 60 wt % to 99 wt %, particularly preferably from 65 wt % to 97 wt %, most preferably from 75 wt % to 97 wt %.

The tackifier resin may contain the tackifier resin TL and a tackifier resin TH having a softening point of 105° C. or more (preferably from 105° C. to 170° C.) in combination because the effect of the present invention can be further expressed.

One or two or more kinds appropriately selected from those each having a softening point of 105° C. or more out of the tackifier resins listed above may each be adopted as the tackifier resin TH. The tackifier resin TH may contain at least one kind selected from rosin-based tackifier resins (e.g., rosin esters) and terpene-based tackifier resins (e.g., a terpene phenol resin).

### (Cross-Linking Agent)

A cross-linking agent may be incorporated into the acrylic pressure-sensitive adhesive. The number of kinds of the cross-linking agents may be only one, or two or more. The use of the cross-linking agent can impart a moderate cohesive strength to the acrylic pressure-sensitive adhesive. The cross-linking agent may be useful in regulating an offset distance and a return distance in a holding power test. The acrylic pressure-sensitive adhesive containing the cross-linking agent may be obtained by, for example, forming the pressure-sensitive adhesive layer through use of a pressure-sensitive adhesive composition containing the cross-linking agent. The cross-linking agent may be incorporated in, for example, a post-cross-linking reaction form, a pre-cross-linking reaction form, a form partially subjected to a cross-linking reaction, or an intermediate or composite form thereof into the acrylic pressure-sensitive adhesive. In typical cases, the cross-linking agent is exclusively incorporated in the post-cross-linking reaction form into the acrylic pressure-sensitive adhesive.

The usage amount of the cross-linking agent is preferably from 0.005 part by weight to 10 parts by weight with respect to 100 parts by weight of the base polymer because the effect of the present invention can be further expressed, and the usage amount is more preferably from 0.01 part by weight to 7 parts by weight, still further more preferably from 0.05 part by weight to 5 parts by weight, particularly preferably from 0.1 part by weight to 4 parts by weight, most preferably from 1 part by weight to 3 parts by weight.

Examples of the cross-linking agent include an isocyanate-based cross-linking agent, an epoxy-based cross-linking agent, a silicone-based cross-linking agent, an oxazoline-based cross-linking agent, an aziridine-based cross-linking agent, a silane-based cross-linking agent, an alkyl etherified melamine-based cross-linking agent, a metal chelate-based cross-linking agent, and a cross-linking agent such as a peroxide. Of those, an isocyanate-based cross-linking agent and an epoxy-based cross-linking agent are preferred because the effect of the present invention can be further expressed, and an isocyanate-based cross-linking agent is more preferred.

A compound having two or more isocyanate groups (including an isocyanate regenerative functional group obtained by temporarily protecting an isocyanate group by means of, for example, a blocking agent or oligomerization) in a molecule thereof may be used as the isocyanate-based cross-linking agent. Examples of the isocyanate-based cross-linking agent include: aromatic isocyanates, such as tolylene diisocyanate and xylene diisocyanate; alicyclic isocyanates, such as isophorone diisocyanate; and aliphatic isocyanates, such as hexamethylene diisocyanate.

More specific examples of the isocyanate-based cross-linking agent include: lower aliphatic polyisocyanates, such as butylene diisocyanate and hexamethylene diisocyanate; alicyclic isocyanates, such as cyclopentylene diisocyanate, cyclohexylene diisocyanate, and isophorone diisocyanate; aromatic diisocyanates, such as 2,4-tolylene diisocyanate, 4,4′-diphenylmethane diisocyanate, xylylene diisocyanate, and polymethylene polyphenyl isocyanate; isocyanate adducts, such as a trimethylolpropane/tolylene diisocyanate trimer adduct (e.g., product name: CORONATE L, manufactured by Tosoh Corporation), a trimethylolpropane/hexamethylene diisocyanate trimer adduct (e.g., product name: CORONATE HL, manufactured by Tosoh Corporation), and an isocyanurate form of hexamethylene diisocyanate (e.g., product name: CORONATE HX, manufactured by Tosoh Corporation); a trimethylolpropane adduct of xylylene diisocyanate (e.g., product name: TAKENATE D110N, manufactured by Mitsui Chemicals, Inc.), a trimethylolpropane adduct of xylylene diisocyanate (e.g., product name: TAKENATE D120N, manufactured by Mitsui Chemicals, Inc.), a trimethylolpropane adduct of isophorone diisocyanate (e.g., product name: TAKENATE D140N, manufactured by Mitsui Chemicals, Inc.), and a trimethylolpropane adduct of hexamethylene diisocyanate (e.g., product name: TAKENATE D160N, manufactured by Mitsui Chemicals, Inc.); polyether polyisocyanate, polyester polyisocyanate, and adducts of those compounds and various polyols; and polyisocyanates each of which is polyfunctionalized with an isocyanurate bond, a biuret bond, or an alophanate bond. Of those, aromatic isocyanates and alicyclic isocyanates are preferred from the viewpoint that the deformability and the cohesive strength can be well balanced.

The usage amount of the isocyanate-based cross-linking agent is preferably from 0.005 part by weight to 10 parts by weight with respect to 100 parts by weight of the base polymer because the effect of the present invention can be further expressed, and the usage amount is more preferably from 0.01 part by weight to 7 parts by weight, still more preferably from 0.05 part by weight to 5 parts by weight, particularly preferably from 0.1 part by weight to 4 parts by weight, most preferably from 1 part by weight to 3 parts by weight.

When the monomer components for forming the acrylic polymer contain a hydroxy group-containing monomer, a weight ratio “isocyanate-based cross-linking agent/hydroxy group-containing monomer” is preferably more than 20 and less than 50 because the effect of the present invention can be further expressed, and the weight ratio is more preferably from 22 to 45, still more preferably from 25 to 40, particularly preferably from 27 to 40, most preferably from 30 to 35.

When the acrylic pressure-sensitive adhesive contains the tackifier resin TL having a softening point of 105° C. or less, a weight ratio “tackifier resin TL/isocyanate-based cross-linking agent” is preferably more than 2 and less than 15 because the effect of the present invention can be further expressed, and the weight ratio is more preferably from 5 to 13, still more preferably from 7 to 12, particularly preferably from 7 to 11.

A polyfunctional epoxy compound having two or more epoxy groups in a molecule thereof may be used as the epoxy-based cross-linking agent. Examples of the epoxy-based cross-linking agent include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic acid diglycidyl ester, triglycidyl-tris(2-hydroxyethyl) isocyanurate, resorcin diglycidyl ether, bisphenol-S-diglycidyl ether, and an epoxy-based resin having two or more epoxy groups in a molecule thereof. As a commercial product of the epoxy-based cross-linking agent, there is given, for example, a product available under the product name “TETRAD C” or “TETRAD X” from Mitsubishi Gas Chemical Company.

The usage amount of the epoxy-based cross-linking agent is preferably from 0.005 part by weight to 10 parts by weight with respect to 100 parts by weight of the base polymer because the effect of the present invention can be further expressed, and the usage amount is more preferably from 0.01 part by weight to 5 parts by weight, still more preferably from 0.015 part by weight to 1 part by weight, still further more preferably from 0.015 part by weight to 0.5 part by weight, particularly preferably from 0.015 part by weight to 0.3 part by weight, most preferably from 0.15 part by weight to 0.3 part by weight.

### (Other Components)

The acrylic pressure-sensitive adhesive may contain any one of various additives that are general in the field of a pressure-sensitive adhesive, such as a leveling agent, a cross-linking aid, a plasticizer, a softening agent, a filler, an antistatic agent, an age resistor, a UV absorber, an antioxidant, and a light stabilizer, as required. Conventionally known additives may be used as such various additives by ordinary methods.

### <<Matt Coating Layer>>

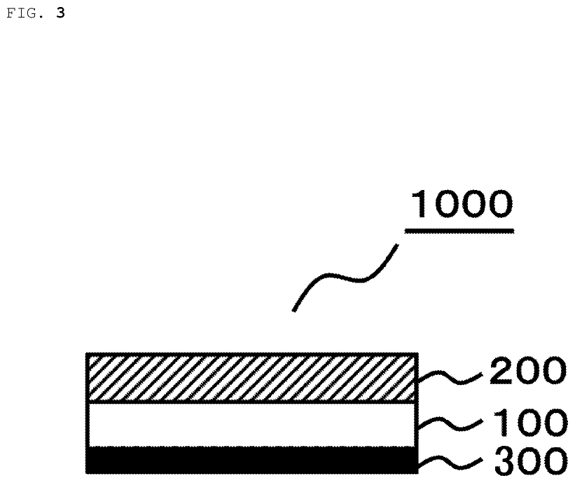

The pressure-sensitive adhesive tape of the present invention may include the pressure-sensitive adhesive layer on one side of the base material layer, and include a matt coating layer on the other side of the base material layer. In this case, the pressure-sensitive adhesive tape of the present invention becomes a single-sided pressure-sensitive adhesive tape including the pressure-sensitive adhesive layer only on one side of the base material layer. That is, as illustrated in FIG. 3, the pressure-sensitive adhesive tape 1000 of the present invention is a pressure-sensitive adhesive tape (single-sided pressure-sensitive adhesive tape) including the pressure-sensitive adhesive layer 200 only on one side of the base material layer 100, and may include a matt coating layer 300 on the side of the base material layer 100 opposite to the pressure-sensitive adhesive layer 200.

When the pressure-sensitive adhesive tape of the present invention includes the matt coating layer as described above, its blocking resistance is improved, and the effect of the present invention can be further expressed.

The thickness of the matt coating layer is preferably from 0.5 μm to 10 μm, more preferably from 1 μm to 8 μm, still more preferably from 1 μm to 5 μm, most preferably from 1 μm to 3 μm. When the thickness of the matt coating layer falls within the ranges, the blocking resistance is improved, and the effect of the present invention can be further expressed.

The surface roughness Sa of the matt coating layer is preferably from 0.3 μm to 0.9 μm, more preferably from 0.4 μm to 0.8 μm. When the surface roughness Sa of the matt coating layer falls within the ranges, the blocking resistance is improved, and the effect of the present invention can be further expressed.

Herein, the surface roughness Sa is a surface roughness (arithmetic average height) defined by ISO 25178, and may be measured with, for example, a laser microscope “OLS 4000” manufactured by Olympus Corporation (MPLAPONLEXT 20 is used as an objective lens) under a measurement environment at 23° C. and 50% RH as described later.

The matt coating layer is formed of a material having applied thereto a matt coating material formed of: a resin serving as a binder; a matting agent for imparting unevenness to the surface of the layer to provide a matt feeling; and an organic solvent in which these materials are to be dissolved or dispersed. A vinyl-based copolymer of, for example, vinyl chloride and vinyl acetate, an acrylic copolymer, a urethane-acrylic copolymer formed of a urethane resin and an acrylic resin, urethane resins, and the like may each be used as the resin serving as a binder. The urethane resins are each preferably used because of its satisfactory adhesiveness with the base material layer in the present invention. Inorganic solid particles may be used as the matting agent, and the mixing of the particles with the resin serving as a binder can impart unevenness to the matt coating layer. For example, calcium carbonate, calcium silicate, magnesium silicate, silica, barium sulfate, zinc oxide, titanium oxide, clay, or alumina may be used. In the present invention, silica particles are preferably used because of their satisfactory affinity for the resin layer serving as a binder and their satisfactory moist heat resistance. The organic solvent only needs to be a solvent in which the resin serving as a binder and the matting agent can be dissolved or dispersed. For example, ketones, such as acetone and methyl ethyl ketone, acetic acid esters, such as methyl acetate and ethyl acetate, aromatic hydrocarbons, such as toluene, xylene, and ethylbenzene, amides, such as N-methylpyrrolidone and N,N-dimethylformamide, and alcohols, such as methanol and ethanol, may each be used. Further, a known surfactant or antistatic agent, an antiblocking agent such as a wax, a curing agent, or the like may be used by being mixed into the matt coating material in accordance with purposes.

The matt coating layer may be formed by using any one of various coating methods, such as a comma coater, a die coater, and flexographic printing. In the present invention, to achieve a preferred thickness of the matt coating layer, the layer is preferably formed by a gravure coating method, such as microgravure coating or reverse gravure coating.

### <<<<Applications>>>>

The pressure-sensitive adhesive tape of the present invention is excellent in unevenness followability. The tape may be preferably used in, for example, a mode in which the tape is bonded to a member having a movable bending portion through exploitation of the feature.

### EXAMPLES

Now, the present invention is more specifically described by way of Examples and Comparative Example. However, the present invention is by no means limited thereto. In the following description, the terms “part(s)” and “%” are by weight unless otherwise stated.

### <Dimensional Change Ratio>

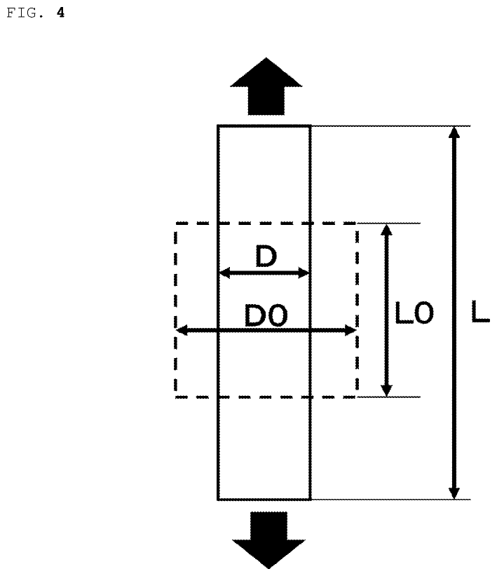

A pressure-sensitive adhesive tape was cut into a belt shape having a width of 20 mm to produce a measurement sample. Under an environment at 23° C. and 50% RH, the measurement sample was tensioned with a tensile tester (manufactured by Shimadzu Corporation, name: Autograph AG-IS) at an initial chuck-to-chuck distance set to 20 mm and a tensile rate of 300 mm/min in its longitudinal direction so that its deformation amount became 100% (i.e., the length of the measurement sample became twice as long as its original length), followed by the calculation of its dimensional change ratio in accordance with the following equation. As illustrated in FIG. 4, L represents the length of the sample in the longitudinal direction (tensile direction) after the tension, and D represents the length thereof in its lateral direction (direction perpendicular to the tensile direction) after the tension.

Dimensional change ratio={(D−D0)/D0}/{(L−L0)/L0}

### <Young's Modulus>

The Young's modulus of a pressure-sensitive adhesive tape serving as a sample is calculated on the basis of the results of a 20% elongation test performed under the following conditions. The same method is adopted in Examples and Comparative Example to be described later.

[20% Elongation Test]

Sample shape: A belt shape having a width of 10 mm

Initial chuck-to-chuck distance: 20 mm

Tensile rate: 300 mm/min

Tensile deformation amount: 20%

Procedure: Under a measurement environment at 23° C. and 50% RH, the sample was clamped by the chucks of a tensile tester so that the initial chuck-to-chuck distance became 20 mm. Then, the sample was elongated at the tensile rate until the chuck-to-chuck distance became 24 mm (20% elongation), followed by the calculation of its Young's modulus from the results of its displacement and stress thus obtained.

A tensile direction in the test is not particularly limited, but is preferably matched with the lengthwise direction of the pressure-sensitive adhesive tape. A product available under the product name “Autograph AG-10G Tensile Tester” from Shimadzu Corporation may be used as the tensile tester.

### <Maximum Stress>

The maximum stress of a pressure-sensitive adhesive sheet serving as a sample is calculated on the basis of the results of a 100% elongation test performed under the following conditions. The same method is adopted in Examples and Comparative Example to be described later.

[100% Elongation Test]

Sample shape: A belt shape having a width of 10 mm

Initial chuck-to-chuck distance: 20 mm

Tensile rate: 300 mm/min

Tensile deformation amount: 100%

Procedure: Under a measurement environment at 23° C. and 50% RH, the sample was clamped by the chucks of a tensile tester so that the initial chuck-to-chuck distance became 20 mm. Then, the maximum stress (tensile stress) (MPa) at the time of the elongation of the sample at the tensile rate until the chuck-to-chuck distance became 40 mm (100% elongation) was measured, and was adopted as the maximum stress.

### <Stress Ratio (B/A)>

A ratio between a tensile stress (A) immediately after the 100% elongation in the 100% elongation test and a tensile stress (B) after the lapse of 1 second in a state in which the 100% elongation was held was adopted as a stress ratio (B/A).

### <Pressure-Sensitive Adhesive Strength>

### (In the Case of Double-Sided Pressure-Sensitive Adhesive Tape)

The pressure-sensitive adhesive strength of a pressure-sensitive adhesive tape refers to a 180-degree peel strength (180-degree peeling pressure-sensitive adhesive strength) to a stainless-steel plate. The 180-degree peel strength was measured as described below. A single-sided pressure-sensitive adhesive tape (product name: “No. 31B”, manufactured by Nitto Denko Corporation, total thickness: 50 μm) was bonded to the pressure-sensitive adhesive layer surface of any one of the two pressure-sensitive adhesive layers of the pressure-sensitive adhesive tape, and then the pressure-sensitive adhesive tape was cut into a size measuring 20 mm wide by 100 mm long to provide a measurement sample. Under an environment at 23° C. and 50% RH, a 2-kilogram roll was reciprocated once to pressure-bond the adhesive surface of the measurement sample onto the surface of a stainless-steel plate (SUS304BA plate). The resultant was left to stand under the environment for 30 minutes, and then its peel strength (N/20 mm) was measured with a universal tensile and compression testing machine in conformity with JIS Z 0237:2000 under the conditions of a tensile rate of 300 mm/min and a peel angle of 180°. A testing machine available under the product name “Autograph AG-10G Tensile Tester” from Shimadzu Corporation was used as the universal tensile and compression testing machine.

### (In the Case of Single-Sided Pressure-Sensitive Adhesive Tape)

The pressure-sensitive adhesive strength of a pressure-sensitive adhesive tape refers to a 180-degree peel strength (180-degree peeling pressure-sensitive adhesive strength) to a stainless-steel plate. The 180-degree peel strength was measured as described below. A single-sided pressure-sensitive adhesive tape (product name: “No. 31B”, manufactured by Nitto Denko Corporation, total thickness: 50 μm) was bonded to the back surface (surface of the base material layer on which no pressure-sensitive adhesive layer was formed) of the pressure-sensitive adhesive tape, and then the pressure-sensitive adhesive tape was cut into a size measuring 20 mm wide by 100 mm long to provide a measurement sample. Under an environment at 23° C. and 50% RH, a 2-kilogram roll was reciprocated once to pressure-bond the adhesive surface of the measurement sample onto the surface of a stainless-steel plate (SUS304BA plate). The resultant was left to stand under the environment for 30 minutes, and then its peel strength (N/20 mm) was measured with a universal tensile and compression testing machine in conformity with JIS Z 0237:2000 under the conditions of a tensile rate of 300 mm/min and a peel angle of 180°. A testing machine available under the product name “Autograph AG-10G Tensile Tester” from Shimadzu Corporation was used as the universal tensile and compression testing machine.

### <Measurement of Surface Roughness Sa>

A surface roughness (Sa) was measured with a laser microscope “OLS 4000” manufactured by Olympus Corporation under a measurement environment at 23° C. and 50% RH. MPLAPONLEXT 20 was used as an objective lens.

### <Flexibility Evaluation>

### (In the Case of Double-Sided Tape)

The pressure-sensitive adhesive tape was cut into a belt shape having a width of 10 mm to produce a test sample. Under an environment at 23° C. and 50% RH, a 2-kilogram roller was reciprocated once to pressure-bond the exposed pressure-sensitive adhesive surface of the test sample onto a PET film (manufactured by Toray Industries, Inc., S10, thickness: 100 μm) serving as an adherend, and then the release liner of the sample was peeled. Baby powder (SICCAROL DEO manufactured by Wakodo Co., Ltd.) was applied to the exposed pressure-sensitive adhesive layer surface of the sample so that its pressure-sensitive adhesive strength disappeared. Thus, a test piece having a width of 10 mm and a length of 200 mm was produced. The test sample thus produced was left to stand under the environment for 5 minutes. The short direction of the tape of the test sample was bonded to the test stand of a flex testing machine (manufactured by Yuasa System Co., Ltd., Tension-Free U-shape Folding Test Machine DMLHB-FS) so that the PET film faced in a ceiling direction, followed by the evaluation of the flexibility of the sample through repeated performance of a bending test under the following conditions.

Bending radius: 3 mm
Number of times of bending: 200,000 times
Bending direction: inside the PET surface
Test environment: temperature of 23° C. and humidity of 50% RH
A case in which a fold, floating (gap), a wrinkle, or a tint change such as whitening which was able to be visually observed did not occur was indicated by Symbol “⊚”, a case in which only a fold was slightly observable was indicated by Symbol “∘”, and a case in which the sample was not in any one of the states was indicated by Symbol “x”.

### (In the Case of Single-Sided Tape)

The pressure-sensitive adhesive tape was cut into a belt shape having a width of 10 mm to produce a test sample. Under an environment at 23° C. and 50% RH, a release liner was peeled from the test sample. A 2-kilogram roller was reciprocated once to pressure-bond the exposed pressure-sensitive adhesive surface of the test sample onto a PET film (manufactured by Toray Industries, Inc., S10, thickness: 100 μm) serving as an adherend. After that, the resultant was turned into a test piece having a width of 10 mm and a length of 200 mm. The test sample thus produced was left to stand under the environment for 5 minutes. The short direction of the tape of the test sample was bonded to the test stand of a flex testing machine (manufactured by Yuasa System Co., Ltd., Tension-Free U-shape Folding Test Machine DMLHB-FS) so that the PET film faced in a ceiling direction, followed by the evaluation of the flexibility of the sample through repeated performance of a bending test under the following conditions.

Bending radius: 3 mm
Number of times of bending: 200,000 times
Test environment: temperature of 23° C. and humidity of 50% RH
Bending direction: inside the PET surface
A case in which a fold, floating (gap), a wrinkle, or a tint change such as whitening which was able to be visually observed did not occur was indicated by Symbol “⊚”, a case in which only a fold was slightly observable was indicated by Symbol “∘”, and a case in which the sample was not in any one of the states was indicated by Symbol “x”.

### <Blocking Resistance Evaluation>

### (In Case of Double-Sided Pressure-Sensitive Adhesive Tape)

First, an exposed pressure-sensitive adhesive surface of one pressure-sensitive adhesive tape was bonded to a SUS plate, and the bonded product was cut into a size measuring 250 mm by 250 mm. Next, another pressure-sensitive adhesive tape was cut into a size measuring 50 mm by 200 mm, and a 2-kilogram roller was reciprocated once to bond the tape onto the release liner of the pressure-sensitive adhesive tape bonded to the SUS surface. A load of 500 g was applied to the pressure-sensitive adhesive tape side of the tape-bonded SUS plate thus produced, and the plate was left at rest for 30 minutes. After the load had been removed, a peel strength (N/20 mm) between the release liner surface of the first one pressure-sensitive adhesive tape and the pressure-sensitive adhesive layer surface of the next other pressure-sensitive adhesive tape was measured with a peel tester (tester available under the product name “Autograph AG-10G Tensile Tester” from Shimadzu Corporation) in conformity with JIS Z 0237:2000 under the conditions of a temperature of 23° C., a humidity of 50% RH, a tensile rate of 300 mm/min, and a peel angle of 180°. The blocking resistance of the resultant sample was evaluated as described below on the basis of the magnitude of the peel strength.

⊚: 0.05 N/20 mm or less
∘: more than 0.05 N/20 mm and 0.15 N/20 mm or less
x: more than 0.15 N/20 mm

### (In Case of Single-Sided Pressure-Sensitive Adhesive Tape)

First, the surface of one pressure-sensitive adhesive tape on the side on which no pressure-sensitive adhesive layer was arranged was bonded to a SUS plate with a double-sided tape (No. 5000NS manufactured by Nitto Denko Corporation), and the bonded product was cut into a size measuring 250 mm by 250 mm. Next, another pressure-sensitive adhesive tape was cut into a size measuring 50 mm by 200 mm, and a 2-kilogram roller was reciprocated once to bond the tape onto the release liner of the pressure-sensitive adhesive tape bonded to the SUS surface on the side on which no pressure-sensitive adhesive layer was formed. A load of 500 g was applied to the pressure-sensitive adhesive tape side of the tape-bonded SUS plate thus produced, and the plate was left at rest for 30 minutes. After the load had been removed, a peel strength (N/20 mm) between the release liner surface of the first one pressure-sensitive adhesive tape and the pressure-sensitive adhesive layer surface of the next other pressure-sensitive adhesive tape was measured with a peel tester (tester available under the product name “Autograph AG-10G Tensile Tester” from Shimadzu Corporation) in conformity with JIS Z 0237:2000 under the conditions of a temperature of 23° C., a humidity of 50% RH, a tensile rate of 300 mm/min, and a peel angle of 180°. The blocking resistance of the resultant sample was evaluated as described below on the basis of the magnitude of the peel strength.

⊚: 0.05 N/20 mm or less
∘: more than 0.05 N/20 mm and 0.15 N/20 mm or less
x: more than 0.15 N/20 mm

### Example 1

30 Parts of 2-ethylhexyl acrylate (2EHA), 70 parts of n-butyl acrylate (BA), 2 parts of acrylic acid (AA), and 0.1 part of 4-hydroxybutyl acrylate (4HBA) serving as monomer components, 0.08 part of 2,2′-azobisisobutyronitrile (AIBN) serving as a polymerization initiator, and 150 parts of toluene serving as a polymerization solvent were loaded into a reaction vessel including a stirring machine, a temperature gauge, a nitrogen gas-introducing tube, and a condenser, and were subjected to solution polymerization at 65° C. for 8 hours to provide a toluene solution of an acrylic polymer (A). The acrylic polymer (A) had a weight-average molecular weight of 440,000.

30 Parts of a tackifier resin TA (manufactured by Harima Chemicals, Inc., hydrogenated rosin glycerin ester, product name: “HARITACK SE10”, softening point: from 75° C. to 85° C.) and 2.7 parts of an isocyanate-based cross-linking agent (manufactured by Tosoh Corporation, product name: “CORONATE L”) were added to 100 parts of the acrylic polymer (A) in the toluene solution. Thus, a pressure-sensitive adhesive composition (A) was prepared.

Two commercial release liners (manufactured by Sumika-Kakoushi Co., Ltd., product name: “SLB-80WD (#1300)” (release liner with release treatment layers on both sides)) were prepared. The pressure-sensitive adhesive composition (A) was applied to one surface (release surface) of each of the release liners so that its thickness after drying became 50 μm, followed by drying at 100° C. for 5 minutes. Thus, 50-micrometer thick pressure-sensitive adhesive layers (a first pressure-sensitive adhesive layer and a second pressure-sensitive adhesive layer) each including an acrylic pressure-sensitive adhesive (A) corresponding to the pressure-sensitive adhesive composition (A) were formed on the release surfaces of the two release liners.

A caprolactam-based (ester-based) polyurethane resin film (A) having a thickness of 100 μm (100% modulus=6.5 MPa) was prepared as a base material layer. The first pressure-sensitive adhesive layer and the second pressure-sensitive adhesive layer formed on the two release liners were bonded to the first surface and second surface of the base material layer. The release liners were left as they were on the pressure-sensitive adhesive layers to be used for the protection of the surfaces (pressure-sensitive adhesive surfaces) of the pressure-sensitive adhesive layers. The resultant structure was passed through a laminator at 80° C. (0.3 MPa, speed: 0.5 m/min) once, and was then wound in a roll shape while one of its release liners was peeled. After that, the resultant was aged in an oven at 50° C. for 1 day. Thus, a pressure-sensitive adhesive tape (1) was obtained.

The results are shown in Table 1.

### Example 2

A pressure-sensitive adhesive composition (B) was prepared in the same manner as in the preparation of the pressure-sensitive adhesive composition (A) in Example 1 except that the usage amount of the isocyanate-based cross-linking agent (manufactured by Tosoh Corporation, product name: “CORONATE L”) was changed to 1.8 parts.

Two commercial release liners (manufactured by Sumika-Kakoushi Co., Ltd., product name: “SLB-80WD (#1300)” (release liner with release treatment layers on both sides)) were prepared. The pressure-sensitive adhesive composition (B) was applied to one surface (release surface) of each of the release liners so that its thickness after drying became 20 μm, followed by drying at 100° C. for 5 minutes. Thus, 20-micrometer thick pressure-sensitive adhesive layers (a first pressure-sensitive adhesive layer and a second pressure-sensitive adhesive layer) each including an acrylic pressure-sensitive adhesive (B) corresponding to the pressure-sensitive adhesive composition (B) were formed on the release surfaces of the two release liners.

A caprolactam-based (ester-based) polyurethane resin film (A) having a thickness of 60 μm (100% modulus=6.5 MPa) was prepared as a base material layer. The first pressure-sensitive adhesive layer and the second pressure-sensitive adhesive layer formed on the two release liners were bonded to the first surface and second surface of the base material layer. The release liners were left as they were on the pressure-sensitive adhesive layers to be used for the protection of the surfaces (pressure-sensitive adhesive surfaces) of the pressure-sensitive adhesive layers. The resultant structure was passed through a laminator at 80° C. (0.3 MPa, speed: 0.5 m/min) once, and was then wound in a roll shape while one of its release liners was peeled. After that, the resultant was aged in an oven at 50° C. for 1 day. Thus, a pressure-sensitive adhesive tape (2) was obtained.

The results are shown in Table 1.

### Example 3

A pressure-sensitive adhesive composition (A) was prepared in the same manner as in Example 1.

Two commercial release liners (manufactured by Sumika-Kakoushi Co., Ltd., product name: “SLB-80WD (#1300)” (release liner with release treatment layers on both sides)) were prepared. The pressure-sensitive adhesive composition (A) was applied to one surface (release surface) of each of the release liners so that its thickness after drying became 10 μm, followed by drying at 100° C. for 5 minutes. Thus, 10-micrometer thick pressure-sensitive adhesive layers (a first pressure-sensitive adhesive layer and a second pressure-sensitive adhesive layer) each including an acrylic pressure-sensitive adhesive (A) corresponding to the pressure-sensitive adhesive composition (A) were formed on the release surfaces of the two release liners.

An ether-based polyurethane resin film (B) having a thickness of 30 μm (100% modulus=5.6 MPa) was prepared as a base material layer. The first pressure-sensitive adhesive layer and the second pressure-sensitive adhesive layer formed on the two release liners were bonded to the first surface and second surface of the base material layer. The release liners were left as they were on the pressure-sensitive adhesive layers to be used for the protection of the surfaces (pressure-sensitive adhesive surfaces) of the pressure-sensitive adhesive layers. The resultant structure was passed through a laminator at 80° C. (0.3 MPa, speed: 0.5 m/min) once, and was then wound in a roll shape while one of its release liners was peeled. After that, the resultant was aged in an oven at 50° C. for 1 day. Thus, a pressure-sensitive adhesive tape (3) was obtained.

The results are shown in Table 1.

### Example 4

A pressure-sensitive adhesive composition (A) was prepared in the same manner as in Example 1.

Two commercial release liners (manufactured by Sumika-Kakoushi Co., Ltd., product name: “SLB-80WD (#1300)” (release liner with release treatment layers on both sides)) were prepared. The pressure-sensitive adhesive composition (A) was applied to one surface (release surface) of each of the release liners so that its thickness after drying became 10 μm, followed by drying at 100° C. for 5 minutes. Thus, 10-micrometer thick pressure-sensitive adhesive layers (a first pressure-sensitive adhesive layer and a second pressure-sensitive adhesive layer) each including an acrylic pressure-sensitive adhesive (A) corresponding to the pressure-sensitive adhesive composition (A) were formed on the release surfaces of the two release liners.

An ether-based polyurethane resin film (C) having a thickness of 30 μm (100% modulus=2.3 MPa) was prepared as a base material layer. The first pressure-sensitive adhesive layer and the second pressure-sensitive adhesive layer formed on the two release liners were bonded to the first surface and second surface of the base material layer. The release liners were left as they were on the pressure-sensitive adhesive layers to be used for the protection of the surfaces (pressure-sensitive adhesive surfaces) of the pressure-sensitive adhesive layers. The resultant structure was passed through a laminator at 80° C. (0.3 MPa, speed: 0.5 m/min) once, and was then wound in a roll shape while one of its release liners was peeled. After that, the resultant was aged in an oven at 50° C. for 1 day. Thus, a pressure-sensitive adhesive tape (4) was obtained.

The results are shown in Table 1.

### Example 5

A pressure-sensitive adhesive composition (A) was prepared in the same manner as in Example 1.

The pressure-sensitive adhesive composition (A) was applied to one surface (release surface) of a commercial release liner (manufactured by Sumika-Kakoushi Co., Ltd., product name: “SLB-80WD (#1300)” (release liner with release treatment layers on both sides)) so that its thickness after drying became 15 μm, followed by drying at 100° C. for 5 minutes. Thus, a 15-micrometer thick pressure-sensitive adhesive layer including an acrylic pressure-sensitive adhesive (A) corresponding to the pressure-sensitive adhesive composition (A) was formed on the release surface of the release liner.

An ether-based polyurethane resin film (C) having a thickness of 50 μm (100% modulus=2.3 MPa) was prepared as a base material layer. The pressure-sensitive adhesive layer formed on the release liner was bonded to one surface of the base material layer. The release liner was left as it was on the pressure-sensitive adhesive layer to be used for the protection of the surface (pressure-sensitive adhesive surface) of the pressure-sensitive adhesive layer.

Next, the other surface of the base material layer was coated with a toluene dispersion liquid, which had been obtained by mixing a resin with silica particles, with a gravure coater, and the dispersion liquid was dried at 80° C. for 1 minute. Thus, a matt coating layer having a thickness of 2 μm was formed.

The resultant structure was passed through a laminator at 80° C. (0.3 MPa, speed: 0.5 m/min) once, and was then wound in a roll shape, and the resultant was aged in an oven at 50° C. for 1 day. Thus, a pressure-sensitive adhesive tape (5) was obtained.

The results are shown in Table 1.

### Example 6

A pressure-sensitive adhesive tape (6) was obtained in the same manner as in Example 5 except that no matt coating layer was formed.

The results are shown in Table 1.

### Comparative Example 1

A pressure-sensitive adhesive composition (A) was prepared in the same manner as in Example 1.

Two commercial release liners (manufactured by Sumika-Kakoushi Co., Ltd., product name: “SLB-80WD (#1300)” (release liner with release treatment layers on both sides)) were prepared. The pressure-sensitive adhesive composition (A) was applied to one surface (release surface) of each of the release liners so that its thickness after drying became 19 μm, followed by drying at 100° C. for 5 minutes. Thus, 19-micrometer thick pressure-sensitive adhesive layers (a first pressure-sensitive adhesive layer and a second pressure-sensitive adhesive layer) each including an acrylic pressure-sensitive adhesive (A) corresponding to the pressure-sensitive adhesive composition (A) were formed on the release surfaces of the two release liners.

A PET base material (D) having a thickness of 12 μm (manufactured by Toray Industries, Inc., product name: “LUMIRROR S10”) was prepared as a base material layer. The first pressure-sensitive adhesive layer and the second pressure-sensitive adhesive layer formed on the two release liners were bonded to the first surface and second surface of the base material layer. The release liners were left as they were on the pressure-sensitive adhesive layers to be used for the protection of the surfaces (pressure-sensitive adhesive surfaces) of the pressure-sensitive adhesive layers. The resultant structure was passed through a laminator at 80° C. (0.3 MPa, speed: 0.5 m/min) once, and was then wound in a roll shape while one of its release liners was peeled. After that, the resultant was aged in an oven at 50° C. for 1 day. Thus, a pressure-sensitive adhesive tape (C1) was obtained.

The results are shown in Table 1.

TABLE 1

| | | | | | | | | Comparative |
|---|---|---|---|---|---|---|---|---|
| | | Example 1 | Example 2 | Example 3 | Example 4 | Example 5 | Example 6 | Example 1 |
| Configuration | Base material | A | A | B | C | C | C | D |
| | layer | | | | | | | |
| | Pressure-sensitive | A | B | A | A | A | A | A |
| | adhesive layer | | | | | | | |
| | Matt coating layer | — | — | — | — | Present | — | — |
| Thickness (μm) | Matt coating layer | — | — | — | — | 2 | — | — |
| | Pressure-sensitive | 50 | 20 | 10 | 10 | — | — | 19 |
| | adhesive layer | | | | | | | |
| | Base material layer | 100 | 60 | 30 | 30 | 50 | 50 | 12 |
| | Pressure-sensitive | 50 | 20 | 10 | 10 | 15 | 15 | 19 |
| | adhesive layer | | | | | | | |
| | Release liner | 122 | 122 | 122 | 122 | 122 | 122 | 122 |
| | Total thickness | 200 | 100 | 50 | 50 | 67 | 65 | 50 |
| | (excluding release | | | | | | | |
| | liner) | | | | | | | |
| Thickness ratio | Pressure-sensitive | 0.500 | 0.400 | 0.400 | 0.400 | 0.224 | 0.231 | 0.760 |
| | adhesive layer/total | | | | | | | |
| | thickness | | | | | | | |

| | | | | | | | |
|---|---|---|---|---|---|---|---|
| Surface roughness Sa of matt coating | — | — | — | — | 0.619 | — | — |
| layer | | | | | | | |
| Dimensional change ratio | −0.31 | −0.27 | −0.28 | −0.28 | −0.28 | −0.28 | −0.40 |
| Young's modulus (MPa) | 7.1 | 9.3 | 9.0 | 2.1 | 2.6 | 2.4 | 67 |
| Maximum stress (MPa) | 3.2 | 4.0 | 3.9 | 1.1 | 1.3 | 1.2 | 55 |
| Stress ratio (B/A) | 0.82 | 0.84 | 0.83 | 0.96 | 0.94 | 0.95 | 0.66 |
| Pressure-sensitive adhesive strength | 13 | 7.5 | 7.5 | 7.0 | 7.2 | 7.2 | 9.0 |
| to SUS | | | | | | | |
| (N/20 mm) | | | | | | | |
| Flexibility evaluation | ◯ | ◯ | ◯ | ◯ | ⊚ | ◯ | X |
| Blocking resistance evaluation | ◯ | ◯ | ◯ | ◯ | ⊚ | ◯ | ◯ |

### INDUSTRIAL APPLICABILITY

The pressure-sensitive adhesive tape of the present invention is excellent in unevenness followability, and hence may be preferably utilized as, for example, a pressure-sensitive adhesive tape to be bonded to a member having a movable bending portion.

### REFERENCE SIGNS LIST

1000 pressure-sensitive adhesive tape
100 base material layer
200 pressure-sensitive adhesive layer
200a pressure-sensitive adhesive layer
200b pressure-sensitive adhesive layer
300 matt coating layer

1. A pressure-sensitive adhesive tape, comprising:
a base material layer; and
a pressure-sensitive adhesive layer arranged on at least one side of the base material layer,
wherein the pressure-sensitive adhesive tape has a dimensional change ratio at 23° C. and 50% RH of from −0.39 to −0.20,
provided that the dimensional change ratio at 23° C. and 50% RH is calculated in accordance with the following equation by: cutting the pressure-sensitive adhesive tape into a belt shape having a width of 20 mm to produce a measurement sample; and
tensioning the measurement sample under an environment at 23° C. and 50% RH with a tensile tester (manufactured by Shimadzu Corporation, name: Autograph AG-IS) at an initial chuck-to-chuck distance set to 20 mm and a tensile rate of 300 mm/min in a longitudinal direction of the measurement sample so that a deformation amount thereof becomes 100% (i.e., a length thereof becomes twice as long as an original length thereof):
Dimensional change ratio={(D−D0)/D0}/{(L−L0)/L0}
where L represents a length thereof in the longitudinal direction (tensile direction) after the tension, and D represents a length thereof in a lateral direction thereof (direction perpendicular to the tensile direction) after the tension.

2. The pressure-sensitive adhesive tape according to claim 1, wherein the pressure-sensitive adhesive tape has a Young's modulus at 23° C. and 50% RH of from 0.2 MPa to 25 MPa.

3. The pressure-sensitive adhesive tape according to claim 1, wherein the pressure-sensitive adhesive tape has a maximum stress of from 0.1 MPa to 10 MPa at a time of tension thereof by 100% at 23° C. and 50% RH and a tensile rate of 300 mm/min.

4. The pressure-sensitive adhesive tape according to claim 1, wherein a ratio (B/A) between a stress A applied to the pressure-sensitive adhesive tape immediately after the pressure-sensitive adhesive tape is tensioned by 100% at 23° C. and 50% RH and a tensile rate of 300 mm/min, and a stress B after holding of the 100% tension state for 1 second is from 0.7 to 1.0.

5. The pressure-sensitive adhesive tape according to claim 1, wherein the pressure-sensitive adhesive layer has a pressure-sensitive adhesive strength to a SUS plate of 5 N/20 mm or more at 23° C. and 50% RH, a tensile rate of 300 mm/min, and a peel angle of 180°.

6. The pressure-sensitive adhesive tape according to claim 1, wherein the pressure-sensitive adhesive tape comprises the pressure-sensitive adhesive layer on one side of the base material layer, and further comprises a matt coating layer on another side of the base material layer.

7. The pressure-sensitive adhesive tape according to claim 6, wherein the matt coating layer has a surface roughness Sa of from 0.3 μm to 0.9 μm.

8. The pressure-sensitive adhesive tape according to claim 1, wherein the pressure-sensitive adhesive tape has a total thickness “d” of from 1 μm to 500 μm.

9. The pressure-sensitive adhesive tape according to claim 8, wherein a ratio (d1/d) of a total thickness d1 of the pressure-sensitive adhesive layer to the total thickness “d” is 0.7 or less.

10. The pressure-sensitive adhesive tape according to claim 1, wherein the base material layer contains at least one polar functional group-containing polymer selected from a condensation-type polymer and a polyaddition-type polymer.

11. The pressure-sensitive adhesive tape according to claim 10, wherein the polar functional group-containing polymer is at least one kind selected from polyamide, polyurethane, and polyurea.

12. The pressure-sensitive adhesive tape according to claim 10, wherein the polar functional group-containing polymer has at least one kind selected from an ether bond and an ester bond.

13. The pressure-sensitive adhesive tape according to claim 1, wherein the pressure-sensitive adhesive layer contains at least one kind selected from an acrylic pressure-sensitive adhesive, a rubber-based pressure-sensitive adhesive, a silicone-based pressure-sensitive adhesive, and a urethane-based pressure-sensitive adhesive.

14. The pressure-sensitive adhesive tape according to claim 1, wherein the pressure-sensitive adhesive tape is a rolled body.
